(19) United States
(12) Patent Application Publication
(10) Pub. No.: US 2021/0238443 A1
(43) Pub. Date: Aug. 5, 2021

(54) LOW-NCO POLYISOCYANATE COMPOSITIONS

(71) Applicant: Covestro LLC, Pittsburgh, PA (US)

(72) Inventors: Daniel P. Wang, Pittsburgh, PA (US); Kurt E. Best, Wexford, PA (US)

(21) Appl. No.: 16/894,952

(22) Filed: Jun. 8, 2020

Related U.S. Application Data
(60) Provisional application No. 62/967,770, filed on Jan. 30, 2020.

(51) Int. Cl. C09D 175/04

(52) U.S. Cl. CPC C09D 175/04

(57) ABSTRACT

A polyisocyanate composition can include an aliphatic polyisocyanate resin having a weight average molecular weight of from 1000-6000 g/mol based on gel permeation chromatography. The aliphatic polyisocyanate resin can include a blend of at least two different aliphatic polyisocyanates and can include less than 50 wt % of a cycloaliphatic polyisocyanate based on a total weight of the aliphatic polyisocyanate resin. The polyisocyanate composition can have an NCO % of from 2 wt % to 18 wt % based on ISO 11909:2007. The polyisocyanate composition can include from 84 wt % to 100 wt % solids.

### BACKGROUND

Compositions based on isocyanate chemistry find utility as components in coatings, such as, for example, paints, primers, and the like. Isocyanate-based coating compositions may include, for example, polyurethane or polyurea coatings formed from resins comprising components, such as, for example, diisocyanates, polyisocyanates, isocyanate reaction products, the like, or a combination thereof. These resins may cure by various mechanisms so that covalent bonds form between the resin components, thereby producing a cross-linked polymer network.

Environmental regulations are imposing increasingly lower volatile organic compound (VOC) limits on various coating compositions, such as architectural and industrial maintenance coatings, for example. In some jurisdictions, government regulations permit the use of “exempt solvents” that do not apply toward the VOC limit in coatings. Examples of “exempt solvents” include HFE-134, HFE-236ca12, HFE-338pcc13, H-Galden 1040X, HFE-347pcf2, HFO-1336mzz-Z, trans-1-chloro-3,3,3-trifluoroprop-1-ene, 2,3,3,3-tetrafluorpropene, 2-amino-2-methyl-1-propanol, and t-butyl acetate. In jurisdictions where the use of “exempt solvents” is permitted, they can help mitigate some of the challenges associated with coating compositions required to have increasingly lower solvent content. Such challenges can include increased viscosity, decreased pot life, etc. However, the use of “exempt solvents” is only a temporary solution and novel approaches are needed to achieve coating compositions having low VOCs without having to rely on “exempt solvents.”

### DETAILED DESCRIPTION

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this written description, the singular forms “a,” “an” and “the” include express support for plural referents unless the context clearly dictates otherwise. Thus, for example, reference to “a polymer” or “the polymer” can include a plurality of such polymers.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in this written description it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 milligrams to about 80 milligrams” should also be understood to provide support for the range of “50 milligrams to 80 milligrams.” Furthermore, it is to be understood that in this specification support for actual numerical values is provided even when the term “about” is used therewith. For example, the recitation of “about” 30 should be construed as not only providing support for values a little above and a little below 30, but also for the actual numerical value of 30 as well. Unless otherwise specified, all numerical parameters are to be understood as being prefaced and modified in all instances by the term “about,” in which the numerical parameters possess the inherent variability characteristic of the underlying measurement techniques used to determine the numerical value of the parameter.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “1 to 5” should be interpreted to include not only the explicitly recited values of 1 to 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

As described above, various coating compositions are subject to environmental regulations imposing increasingly stricter limits on volatile organic compounds (VOCs). However, reducing the amount of solvents in a coating can affect the coating composition in a number of ways. As non-limiting examples, reducing the amount of solvents in the coating composition can increase the starting viscosity of the coating composition and the rate of viscosity build, which can both negatively impact the pot life of the coating composition, for example.

The present disclosure describes a solution to this problem. More specifically, the present disclosure describes a polyisocyanate composition that can be used to formulate a low-VOC coating composition with a reasonable pot life. In general, the polyisocyanate composition can have an NCO % of from 2 wt % to 18 wt % based on ISO 11909:2007. Additionally, the polyisocyanate composition can generally include an aliphatic polyisocyanate resin having a weight average molecular weight of from 1000-6000 g/mol based on gel permeation chromatography. The aliphatic polyisocyanate resin can include a blend of at least two different aliphatic polyisocyanates. Where the aliphatic polyisocyanate resin includes a cycloaliphatic polyisocyanate, the cycloaliphatic polyisocyanate can generally be included in the aliphatic polyisocyanate resin in an amount less than 50 wt % based on a total weight of the aliphatic polyisocyanate resin. The polyisocyanate composition also generally includes from 84 wt % to 100 wt % solids.

As described previously, the polyisocyanate composition can generally have a relatively low NCO content. This can allow the polyisocyanate to be combined with an isocyanate-reactive component (e.g., a polyaspartate composition) without crosslinking too quickly, which can help extend the pot life of the coating composition. More specifically, a relatively low NCO % can decrease the rate of viscosity build in the coating composition after combining the polyisocyanate composition with an isocyanate-reactive composition. As such, the polyisocyanate composition can generally have a relatively low NCO %, such as from 2 wt % to 18 wt % based on ISO 11909:2007. In additional examples, the polyisocyanate composition can have an NCO % of from 7.7 wt % to 17.7 wt % based on ISO 11909:2007. In still additional examples, the polyisocyanate composition can have an NCO % of from 8 wt % to 17.4 wt %, from 9 wt % to 17.2 wt %, from 10 wt % to 17 wt %, or from 11 wt % to 16.8 wt % based on ISO 11909:2007.

As also described previously, the polyisocyanate composition generally has a high solids content. For example, the polyisocyanate composition generally has a solids content of from 84 wt % to 100 wt % based on a total weight of the polyisocyanate composition. In some examples, the polyisocyanate composition can include at least 84 wt %, at least 85 wt %, at least 86 wt %, at least 87 wt %, at least 88 wt %, or at least 89 wt % solids based on a total weight of the polyisocyanate composition. In some examples, it can be beneficial to include some solvent in the polyisocyanate composition to provide a comparatively lower initial viscosity to the coating composition. Thus, in some examples, the polyisocyanate composition can include up to 97 wt % solids, up to 96 wt % solids, up to 95 wt % solids, up to 94 wt % solids, up to 93 wt % solids, up to 92 wt % solids, up to 91 wt % solids, or up to 90 wt % solids based on a total weight of the polyisocyanate composition.

A variety of solvents can be used to dilute the polyisocyanate composition and reduce the viscosity thereof. These solvents can include exempt solvents (e.g., t-butyl acetate), non-exempt solvents, or a combination thereof. In either case, the total amount of solvent in the polyisocyanate composition can generally be less than 16 wt % based on a total weight of the polyisocyanate composition. In some additional examples, the total amount of solvent can be less than 15 wt %, less than 14 wt %, less than 13 wt %, less than 12 wt %, or less than 11 wt % based on a total weight of the polyisocyanate composition. Generally, solvents employed in the polyisocyanate are organic solvents. Non-limiting examples of solvents that can be employed in the polyisocyanate composition can include ethyl acetate, butyl acetate, 1-methoxy propyl-acetate-2, acetone, methyl ethyl ketone, methyl isobutyl ketone, cyclohexanone, toluene, xylene, solvent naphtha, the like, or a combination thereof. Further, the polyisocyanate composition generally includes less than 5 wt % water, less than 4 wt % water, less than 3 wt % water, less than 2 wt % water, less than 1 wt % water, or less than 0.5 wt % water based on a total weight of the polyisocyanate composition. In some additional examples, the polyisocyanate composition includes substantially no water, or only the amount of water that is absorbed from ambient air.

The polyisocyanate composition can also include an aliphatic polyisocyanate resin. The aliphatic polyisocyanate resin can include a variety of aliphatic polyisocyanates. As used herein, the term “polyisocyanate” refers to compounds comprising at least two un-reacted isocyanate groups. The term “diisocyanate” refers to compounds having two un-reacted isocyanate groups. Thus, “diisocyanate” is a subset of “polyisocyanate.” Polyisocyanates can include biurets, isocyanurates, uretdiones, isocyanate-functional urethanes, isocyanate-functional ureas, isocyanate-functional iminooxadiazine diones, isocyanate-functional oxadiazine diones, isocyanate-functional carbodiimides, isocyanate-functional acyl ureas, isocyanate-functional allophanates, the like, or combinations thereof.

As non-limiting examples, isocyanurates may be prepared by the cyclic trimerization of polyisocyanates. Trimerization may be performed, for example, by reacting three (3) equivalents of a polyisocyanate to produce 1 equivalent of isocyanurate ring. The three (3) equivalents of polyisocyanate may comprise three (3) equivalents of the same polyisocyanate compound, or various mixtures of two (2) or three (3) different polyisocyanate compounds. Compounds, such as, for example, phosphines, Mannich bases and tertiary amines, such as, for example, 1,4-diaza-bicyclo[2.2.2]octane, dialkyl piperazines, or the like, may be used as trimerization catalysts. Iminooxadiazines may be prepared by the asymmetric cyclic trimerization of polyisocyanates. Uretdiones may be prepared by the dimerization of a polyisocyanate. Allophanates may be prepared by the reaction of a polyisocyanate with a urethane. Biurets may be prepared via the addition of a small amount of water to two equivalents of polyisocyanate and reacting at slightly elevated temperature in the presence of a biuret catalyst. Biurets may also be prepared by the reaction of a polyisocyanate with a urea.

As previously described, the aliphatic polyisocyanate resin can include a blend of different aliphatic polyisocyanates. As used herein, “different aliphatic polyisocyanates” refers to aliphatic isocyanates differing in at least one characteristic and that can be combined to prepare the aliphatic polyisocyanate resin described herein. As non-limiting examples, the “different aliphatic polyisocyanates” can be different with respect to one or more of NCO % (assuming 100% solids), number average functionality, weight average molecular weight, species of base monomer, type or structure of polyisocyanate adduct or homopolymer, or the like.

In some specific examples, the aliphatic polyisocyanate resin can include a linear aliphatic polyisocyanate component. As used herein, “linear aliphatic polyisocyanate” refers to a polyisocyanate that is prepared from or based on a linear isocyanate monomer, such as 1,4-tetramethylene diisocyanate, 1,5-pentamethylene diisocyanate, or 1,6-hexamethylene diisocyanate. Thus, for example, while the structure of a trimer of 1,6-hexamethylene diisocyanate may not be entirely linear, it is based on the linear monomeric 1,6-hexamethylene diisocyanate and is therefore considered a “linear aliphatic polyisocyanate” for the purposes of this disclosure. Non-limiting examples of linear aliphatic polyisocyanates can include 1,4-tetramethylene diisocyanate, 1,5-pentamethylene diisocyanate (PDI), 1,6-hexamethylene diisocyanate (HDI), a trimer of HDI, a trimer of PDI, a biuret of HDI, a biuret of PDI, an allophanate of HDI, an allophanate of PDI, an allophanate of a trimer of HDI, an allophanate of a trimer of PDI, 2,2,4-trimethyl-hexamethylene diisocyanate, 2,4,4-trimethyl-hexamethylene diisocyanate, dodecamethylene diisocyanate, 2-methyl-1,5-diisocyanatopentane, the like, or a combination thereof.

In some specific examples, the linear aliphatic polyisocyanate can be or include an HDI polyisocyanate. In some additional specific examples, the linear aliphatic polyisocyanate component can be or include a PDI polyisocyanate. In some specific examples, the linear aliphatic polyisocyanate component can be or include a biuret, such as a biuret of HDI, a biuret of PDI, or a combination thereof. In some additional specific examples, the linear aliphatic polyisocyanate component can be or include a trimer, such as a trimer of HDI, a trimer of PDI, or a combination thereof. In still further specific examples, the linear aliphatic polyisocyanate component can be or include an allophanate, such as an allophanate of HDI, an allophanate of PDI, an allophanate of a trimer of HDI, an allophanate of a trimer of PDI, or a combination thereof.

Further, in some examples, the aliphatic polyisocyanate resin can include a cycloaliphatic polyisocyanate component. In some examples, a cycloaliphatic isocyanate can help provide a harder coating in view of the relatively low NCO content of the polyisocyanate composition. Where a cycloaliphatic polyisocyanate is included in the aliphatic polyisocyanate resin, the cycloaliphatic polyisocyanate can generally be included in an amount of less than or equal to 50 wt % based on a total weight of the polyisocyanate resin. In some additional examples, the cycloaliphatic polyisocyanate can be included in the aliphatic polyisocyanate resin in an amount of less than or equal to 40 wt %, less than or equal to 30 wt %, less than or equal to 20 wt %, or less than or equal to 10 wt % based on a total weight of the aliphatic polyisocyanate resin. Thus, in some examples, the cycloaliphatic polyisocyanate can be present in the aliphatic polyisocyanate resin (e.g., in an amount greater than 0 wt %), but less than or equal to 50 wt %, or another specified amount, based on a total amount of the aliphatic polyisocyanate resin. In other examples, the aliphatic polyisocyanate resin does not include a cycloaliphatic polyisocyanate component.

Where included, a variety of cycloaliphatic polyisocyanates can be included in the polyisocyanate composition. Non-limiting examples can include 1-isocyanato-3,3,5-trimethyl-5-isocyanato-methylcyclohexane (IPDI), 2,4-diisocyanato-dicyclohexyl-methane, 4,4′ diisocyanato-dicyclohexyl-methane, 1-isocyanato-1-methyl-3(4)-isocyanatomethyl-cyclohexane (IMCI), 1,4-cyclohexane diisocyanate (CHDI), the like, or a combination thereof. In some specific examples, the cycloaliphatic polyisocyanate can include a secondary isocyanate group. By “secondary isocyanate group,” it is meant an isocyanate group bonded to a secondary carbon atom. In some examples, a secondary isocyanate group can increase the pot life for a corresponding coating composition due to lower reactivity as compared to a primary isocyanate group.

In some specific examples, the cycloaliphatic polyisocyanate can be or include a biuret, a trimer, an allophanate, the like, or a combination thereof. For example, in some cases, the cycloaliphatic polyisocyanate can be or include a trimer, such as a trimer of IPDI, a trimer of 2,4-diisocyanato-dicyclohexyl-methane, a trimer of 4,4′ diisocyanato-dicyclohexyl-methane, a trimer of IMCI, a trimer of CHDI, or a combination thereof. In other examples, the cycloaliphatic polyisocyanate can be or include a biuret, such as a biuret of IPDI, a biuret of 2,4-diisocyanato-dicyclohexyl-methane, a biuret of 4,4′ diisocyanato-dicyclohexyl-methane, a biuret of IMCI, a biuret of CHDI, or a combination thereof. In still additional examples, the cycloaliphatic polyisocyanate can be or include an allophanate, such as an allophanate of IPDI, an allophanate of 2,4-diisocyanato-dicyclohexyl-methane, an allophanate of 4,4′ diisocyanato-dicyclohexyl-methane, an allophanate of IMCI, an allophanate of CHDI, or a combination thereof.

Generally, the cycloaliphatic polyisocyanate can have a relatively high glass transition temperature. In some examples, the cycloaliphatic polyisocyanate can have a glass transition temperature greater than or equal to 25° C. based on differential scanning calorimetry over a temperature range of from −25° C. to 250° C. at a heating and cooling rate of 20° C./min. In some additional examples, the cycloaliphatic polyisocyanate can have a glass transition temperature greater than or equal to 30° C. based on differential scanning calorimetry over a temperature range of from −25° C. to 250° C. at a heating and cooling rate of 20° C./min. In still additional examples, the cycloaliphatic polyisocyanate can have a glass transition temperature of from 25° C. to 45° C. based on differential scanning calorimetry over a temperature range of from −25° C. to 250° C. at a heating and cooling rate of 20° C./min.

Additionally, in some examples, the aliphatic polyisocyanate resin can include an isocyanate-terminated reaction product of an aliphatic polyisocyanate and an isocyanate-reactive material. Where this is the case, the aliphatic polyisocyanate can be or include a linear aliphatic polyisocyanate, a cycloaliphatic polyisocyanate, or a combination thereof. The linear aliphatic polyisocyanate can include one or more of the linear aliphatic polyisocyanates described elsewhere herein. Similarly, the cycloaliphatic polyisocyanate can include one or more of the cycloaliphatic polyisocyanates described elsewhere herein.

A variety of isocyanate-reactive materials can be combined with the aliphatic polyisocyanate and allowed to react to produce the isocyanate-terminated reaction product. For example, the isocyanate-reactive material can generally include a polyol or polyamine that is based on a polyether, a polyester, a polycarbonate, a polycarbonate ester, a polycaprolactone, a polybutadiene, the like, or a combination thereof. In some specific examples, the isocyanate-reactive material can include a polyether polyol. In some additional specific examples, the isocyanate-reactive material can include a polyester polyol. Additionally, the isocyanate-reactive material can generally have a number average molecular weight of from 300 g/mol to 6000 g/mol.

Examples of polyether polyols can be formed from the oxyalkylation of various polyols, for example, glycols such as ethylene glycol, 1,2-1,3- or 1,4-butanediol, 1,6-hexanediol, and the like, or higher polyols, such as trimethylol propane, pentaerythritol and the like. One commonly utilized oxyalkylation method is by reacting a polyol with an alkylene oxide, for example, ethylene oxide or propylene oxide in the presence of a basic catalyst or a coordination catalyst such as a double-metal cyanide (DMC).

Examples of suitable polyester polyols can be prepared by the polyesterification of organic polycarboxylic acids, anhydrides thereof, or esters thereof with organic polyols. Preferably, the polycarboxylic acids and polyols are aliphatic or aromatic dibasic acids and diols.

The diols which may be employed in making the polyester include alkylene glycols, such as ethylene glycol, 1,2-1,3- or 1,4-butanediol, neopentyl glycol and other glycols such as cyclohexane dimethanol, caprolactone diol (for example, the reaction product of caprolactone and ethylene glycol), polyether glycols, for example, poly(oxytetramethylene) glycol and the like. However, other diols of various types and, as indicated, polyols of higher functionality may also be utilized in various embodiments of the invention. Such higher polyols can include, for example, trimethylol propane, trimethylol ethane, pentaerythritol, and the like, as well as higher molecular weight polyols such as those produced by oxyalkylating low molecular weight polyols.

The acid component of the polyester can include primarily monomeric carboxylic acids, or anhydrides thereof, or esters thereof having 2 to 18 carbon atoms per molecule. Among the acids that are useful are phthalic acid, isophthalic acid, terephthalic acid, tetrahydrophthalic acid, hexahydrophthalic acid, adipic acid, succinic acid, azelaic acid, sebacic acid, maleic acid, glutaric acid, chlorendic acid, tetrachlorophthalic acid and other dicarboxylic acids of varying types. Also, there may be employed higher polycarboxylic acids such as trimellitic acid and tricarballylic acid.

In addition to polyester polyols formed from polybasic acids and polyols, polycaprolactone-type polyesters can also be employed. These products are formed from the reaction of a cyclic lactone such as ε-caprolactone with a polyol containing primary hydroxyls such as those mentioned above. Such products are described in U.S. Pat. No. 3,169,949.

Suitable hydroxy-functional polycarbonate polyols may be those prepared by reacting monomeric diols (such as 1,4-butanediol, 1,6-hexanediol, di-, tri- or tetraethylene glycol, di-, tri- or tetrapropylene glycol, 3-methyl-1,5-pentanediol, 4,4′-dimethylolcyclohexane and mixtures thereof) with diaryl carbonates (such as diphenyl carbonate, dialkyl carbonates (such as dimethyl carbonate and diethyl carbonate), alkylene carbonates (such as ethylene carbonate or propylene carbonate), or phosgene. Optionally, a minor amount of higher functional, monomeric polyols, such as trimethylolpropane, glycerol or pentaerythritol, may be used.

In other examples, low molecular weight diols, triols, and higher alcohols may be included in the isocyanate-reactive material. In many embodiments, they can be monomeric and have hydroxyl values of 375 to 1810. Such materials can include aliphatic polyols, particularly alkylene polyols containing from 2 to 18 carbon atoms. Examples include ethylene glycol, 1,4-butanediol, 1,6-hexanediol, and cycloaliphatic polyols such as cyclohexane dimethanol. Examples of triols and higher alcohols include trimethylol propane and pentaerythritol. Also useful are polyols containing ether linkages such as diethylene glycol and triethylene glycol.

Thus, the aliphatic polyisocyanate resin can include a variety of aliphatic polyisocyanates, such as a linear aliphatic polyisocyanate, a cycloaliphatic polyisocyanate, an isocyanate-terminated reaction product of an aliphatic polyisocyanate and an isocyanate-reactive material, or a combination thereof. Further, the aliphatic polyisocyanate resin generally includes a blend of at least two different polyisocyanates. In some examples, the blend can include any suitable combination of at least two different linear aliphatic polyisocyanates, such as a trimer of HDI and a trimer of PDI, a trimer of HDI and a biuret of HDI, an allophanate of a trimer of HDI and a trimer of HDI, an allophanate of PDI and a biuret of PDI, etc. In some examples, the blend can include a linear aliphatic polyisocyanate and a cycloaliphatic polyisocyanate. In some additional examples, the blend can include a linear aliphatic polyisocyanate and an isocyanate-terminated reaction product of an aliphatic polyisocyanate and an isocyanate-reactive material. In some examples, the blend can include a cycloaliphatic polyisocyanate and an isocyanate-terminated reaction product of an aliphatic polyisocyanate and an isocyanate-reactive material. For the sake of brevity, the blend can generally include any suitable combination of at least two different aliphatic polyisocyanates listed or described herein, whether the blend includes one or more linear aliphatic polyisocyanates, one or more cycloaliphatic polyisocyanates, one or more isocyanate-terminated reaction products of an aliphatic polyisocyanate and an isocyanate-reactive material, or a combination thereof. In some specific examples, the blend can include a linear aliphatic polyisocyanate. In some additional specific examples, the blend can include an allophanate.

The aliphatic polyisocyanate resin can have a variety of number average functionalities, such as from 2 to 4.5 based on gel permeation chromatography. In some examples, the aliphatic polyisocyanate resin can have a relatively high number average functionality to help impart suitable final properties to the final coating composition, such as hardness and weatherability, for example. As such, in some examples, the aliphatic polyisocyanate resin can have a number average functionality of from 2.9 to 4.3 based on gel permeation chromatography. In additional examples, the aliphatic polyisocyanate resin can have a number average functionality of from 3.3 to 4.0 based on gel permeation chromatography. In still additional examples, the aliphatic polyisocyanate resin can have a number average functionality of from 3.0 to 4.2, 3.1 to 4.1, 3.2 to 4.1, or 3.3 to 4.0 based on gel permeation chromatography.

The aliphatic polyisocyanate resin can also have a variety of weight average molecular weights. Generally, the aliphatic polyisocyanate resin can have a weight average molecular weight of from 1000 g/mol to 6000 g/mol based on gel permeation chromatography. In some additional examples, the aliphatic polyisocyanate resin can have a weight average molecular weight of from 1200 g/mol to 5800 g/mol based on gel permeation chromatography. In some specific examples, the aliphatic polyisocyanate resin can have a weight average molecular weight of from 1200 g/mol to 2800 g/mol, from 2200 g/mol to 3800 g/mol, from 3200 g/mol to 4800 g/mol, or from 4200 g/mol to 5800 g/mol based on gel permeation chromatography.

As the aliphatic polyisocyanate resin includes a blend of aliphatic polyisocyanates, an aliphatic polyisocyanate resin having a suitable number average functionality and weight average molecular weight can be achieved by combining a variety of aliphatic polyisocyanates. In some specific examples, the aliphatic polyisocyanate resin can include a high-functionality aliphatic polyisocyanate having a number average functionality of from 3.5 to 5 based on gel permeation chromatography and a weight average molecular weight of from 2500 g/mol to 7000 g/mol based on gel permeation chromatography. Where this is the case, the aliphatic polyisocyanate resin can generally include the high-functionality aliphatic polyisocyanate in an amount of from 15 wt % to 100 wt % based on a total weight of the aliphatic polyisocyanate resin. In other examples, the aliphatic polyisocyanate resin can include the high-functionality aliphatic polyisocyanate in an amount of from 20 wt % to 95 wt %, from 25 wt % to 80 wt %, or from 30 wt % to 85 wt % based on a total weight of the aliphatic polyisocyanate resin.

In some examples, a single high-functionality aliphatic polyisocyanate can be included in the aliphatic polyisocyanate resin. In other examples, a plurality of high-functionality aliphatic polyisocyanates can be included in the aliphatic polyisocyanate resin. For example, in some cases, the high-functionality aliphatic polyisocyanate can include a first high-functionality aliphatic polyisocyanate, a second high-functionality aliphatic polyisocyanate, or a combination thereof.

In some specific examples, the first high-functionality aliphatic polyisocyanate can have a number average functionality of from 4 to 5 based on gel permeation chromatography. In some further examples, the first high-functionality polyisocyanate can have a number average functionality of from 4.2 to 4.7, from 4.3 to 4.8, from 4.4 to 4.9, or from 4.5 to 5.0 based on gel permeation chromatography. Additionally, in some examples, the first high-functionality aliphatic polyisocyanate can have an NCO % of from 14 wt % to 22 wt % based on ISO 11909:2007. In some further examples, the first high-functionality aliphatic polyisocyanate can have an NCO % of from 14 wt % to 18 wt %, from 15 wt % to 20 wt %, or from 16 wt % to 21 wt % based on ISO 11909:2007. In some examples, the first high-functionality aliphatic polyisocyanate can have a weight average molecular weight of from 2500 g/mol to 3800 g/mol based on gel permeation chromatography. In some additional examples, the first high-functionality aliphatic polyisocyanate can have a weight average molecular weight of from 2800 g/mol to 3400 g/mol or from 3000 g/mol to 3600 g/mol based on gel permeation chromatography. The first high-functionality aliphatic polyisocyanate can generally include a linear aliphatic polyisocyanate, a cycloaliphatic polyisocyanate, or an isocyanate-functional reaction product of an aliphatic polyisocyanate and an isocyanate-reactive material. In some specific examples, the first high-functionality aliphatic polyisocyanate can include an HDI polyisocyanate. In some additional specific examples, the first high-functionality aliphatic polyisocyanate can include an isocyanate-functional reaction product of an aliphatic polyisocyanate and an isocyanate-reactive material. In some additional examples, the first high-functionality aliphatic polyisocyanate can include an allophanate. In still additional examples, the first high-functionality aliphatic polyisocyanate can include a trimer.

Where the first high-functionality aliphatic polyisocyanate is included in the high-functionality aliphatic polyisocyanate, the first high-functionality aliphatic polyisocyanate can be present in a variety of amounts. Generally, the high-functionality aliphatic polyisocyanate can include the first high-functionality aliphatic polyisocyanate in an amount of from 15 wt % to 100 wt % based on a total weight of the high-functionality aliphatic polyisocyanate. In additional examples, the high-functionality aliphatic polyisocyanate can include the first high-functionality aliphatic polyisocyanate in an amount of from 35 wt % to 99 wt % based on a total weight of the high-functionality aliphatic polyisocyanate. In some specific examples, the high-functionality aliphatic polyisocyanate can include the first high-functionality aliphatic polyisocyanate in an amount of from 35 wt % to 55 wt %, 45 wt % to 65 wt %, 55 wt % to 75 wt %, 65 wt % to 85 wt %, or 75 wt % to 95 wt % based on a total weight of the high-functionality aliphatic polyisocyanate.

In some additional specific examples, the high-functionality aliphatic polyisocyanate can include a second high-functionality aliphatic polyisocyanate. Where this is the case, the second high-functionality aliphatic polyisocyanate can generally have a number average functionality of from 3.5 to 4.5 based on gel permeation chromatography. In some further examples, the second high-functionality polyisocyanate can have a number average functionality of from 3.6 to 4.1, from 3.7 to 4.2, from 3.8 to 4.3, or from 3.9 to 4.4 based on gel permeation chromatography. Additionally, in some examples, the second high-functionality aliphatic polyisocyanate can have an NCO % of from 2 wt % to 10 wt % based on ISO 11909:2007. In some further examples, the second high-functionality aliphatic polyisocyanate can have an NCO % of from 2 wt % to 7 wt %, from 3 wt % to 8 wt %, or from 4 wt % to 9 wt % based on ISO 11909:2007. In some examples, the second high-functionality aliphatic polyisocyanate can have a weight average molecular weight of from 5500 g/mol to 7000 g/mol based on gel permeation chromatography. In some additional examples, the second high-functionality aliphatic polyisocyanate can have a weight average molecular weight of from 5700 g/mol to 6500 g/mol or from 6000 g/mol to 6800 g/mol based on gel permeation chromatography. The second high-functionality aliphatic polyisocyanate can generally include a linear aliphatic polyisocyanate, a cycloaliphatic polyisocyanate, or an isocyanate-functional reaction product of an aliphatic polyisocyanate and an isocyanate-reactive material. In some specific examples, the second high-functionality aliphatic polyisocyanate can include an HDI polyisocyanate. In some additional specific examples, the second high-functionality aliphatic polyisocyanate can include an isocyanate-functional reaction product of an aliphatic polyisocyanate and an isocyanate-reactive material. In some further examples, the second high-functionality aliphatic polyisocyanate can include an allophanate.

Where the second high-functionality aliphatic polyisocyanate is included in the high-functionality aliphatic polyisocyanate, the second high-functionality aliphatic polyisocyanate can be present in a variety of amounts. Generally, the high-functionality aliphatic polyisocyanate can include the second high-functionality aliphatic polyisocyanate in an amount up to 85 wt % based on a total weight of the high-functionality aliphatic polyisocyanate. In additional examples, the high-functionality aliphatic polyisocyanate can include the second high-functionality aliphatic polyisocyanate in an amount of from 1 wt % to 85 wt % based on a total weight of the high-functionality aliphatic polyisocyanate. In still additional examples, the high-functionality aliphatic polyisocyanate can include the second high-functionality aliphatic polyisocyanate in an amount of from 5 wt % to 65 wt % based on a total weight of the high-functionality aliphatic polyisocyanate. In some specific examples, the high-functionality aliphatic polyisocyanate can include the first high-functionality aliphatic polyisocyanate in an amount of from 5 wt % to 25 wt %, 15 wt % to 35 wt %, 25 wt % to 45 wt %, 35 wt % to 55 wt %, or 45 wt % to 65 wt % based on a total weight of the high-functionality aliphatic polyisocyanate.

Where the high-functionality aliphatic polyisocyanate includes the first and the second high-functionality aliphatic polyisocyanates, the first and the second high-functionality aliphatic polyisocyanates can be present in a variety of weight ratios. For example, in some cases, the first high-functionality aliphatic polyisocyanate and the second high-functionality aliphatic polyisocyanate can be present at a weight ratio of from 0.5:1 to 18:1 first to second high-functionality aliphatic polyisocyanate. In some further examples, the first high-functionality aliphatic polyisocyanate and the second high-functionality aliphatic polyisocyanate can be present at a weight ratio of from 1:1 to 7:1 first to second high-functionality aliphatic polyisocyanate. In some specific examples, the first high-functionality aliphatic polyisocyanate and the second high-functionality aliphatic polyisocyanate can be present at a weight ratio of from 0.5:1 to 2:1, from 1:1 to 5:1, from 2:1 to 6:1, from 3:1 to 7:1, or from 4:1 to 10:1 first to second high-functionality aliphatic polyisocyanate. In some examples, the high-functionality aliphatic polyisocyanate can include only the first high-functionality aliphatic polyisocyanate. In other examples, the high-functionality aliphatic polyisocyanate can include only the second high-functionality aliphatic polyisocyanate.

In some examples, the aliphatic polyisocyanate resin can also include a low-functionality aliphatic polyisocyanate having a number average functionality of from 2 to 3.5 based on gel permeation chromatography and a weight average molecular weight of from 500 g/mol to 1500 g/mol based on gel permeation chromatography. Where this is the case, the aliphatic polyisocyanate resin can generally include the low-functionality aliphatic polyisocyanate in an amount of from 0.1 wt % to 85 wt % based on a total weight of the aliphatic polyisocyanate resin. In some examples, the aliphatic polyisocyanate resin can include the low-functionality aliphatic polyisocyanate in an amount of from 5 wt % to 80 wt %, from 10 wt % to 75 wt %, or from 15 wt % to 70 wt % based on a total weight of the aliphatic polyisocyanate resin. In some specific examples, the aliphatic polyisocyanate resin can include the low-functionality aliphatic polyisocyanate in an amount of from 15 wt % to 30 wt %, from 25 wt % to 40 wt %, from 35 wt % to 50 wt %, from 45 wt % to 60 wt %, or from 55 wt % to 70 wt % based on a total weight of the aliphatic polyisocyanate resin.

In some examples, a single low-functionality aliphatic polyisocyanate can be included in the aliphatic polyisocyanate resin. In other examples, a plurality of low-functionality aliphatic polyisocyanates can be included in the aliphatic polyisocyanate resin. For example, in some cases, the low-functionality aliphatic polyisocyanate can include a first high-functionality aliphatic polyisocyanate, a second high-functionality aliphatic polyisocyanate, or a combination thereof.

In some specific examples, the first low-functionality aliphatic polyisocyanate can have a number average functionality of from 2 to 3.5 based on gel permeation chromatography. In some further examples, the first low-functionality polyisocyanate can have a number average functionality of from 2.1 to 2.6, from 2.2 to 2.7, from 2.3 to 2.8, or from 2.4 to 2.9 based on gel permeation chromatography. Additionally, in some examples, the first low-functionality aliphatic polyisocyanate can have an NCO % of from 16 wt % to 25 wt % based on ISO 11909:2007. In some further examples, the first low-functionality aliphatic polyisocyanate can have an NCO % of from 16 wt % to 21 wt %, from 17 wt % to 22 wt %, or from 18 wt % to 23 wt % based on ISO 11909:2007. In some examples, the first low-functionality aliphatic polyisocyanate can have a weight average molecular weight of from 500 g/mol to 1500 g/mol based on gel permeation chromatography. In some additional examples, the first low-functionality aliphatic polyisocyanate can have a weight average molecular weight of from 600 g/mol to 1200 g/mol or from 700 g/mol to 1400 g/mol based on gel permeation chromatography. The first low-functionality aliphatic polyisocyanate can generally include a linear aliphatic polyisocyanate, a cycloaliphatic polyisocyanate, or an isocyanate-functional reaction product of an aliphatic polyisocyanate and an isocyanate-reactive material. In some specific examples, the first low-functionality aliphatic polyisocyanate can include an HDI polyisocyanate. In some additional specific examples, the first low-functionality aliphatic polyisocyanate can include a cycloaliphatic polyisocyanate. In some additional examples, the first low-functionality aliphatic polyisocyanate can include an allophanate. In still additional examples, the first low-functionality aliphatic polyisocyanate can include a timer.

Where a low-functionality aliphatic polyisocyanate includes the first low-functionality aliphatic polyisocyanate, the first low-functionality aliphatic polyisocyanate can generally be included in an amount of from 65 wt % to 100 wt % based on a total weight of the low-functionality aliphatic polyisocyanate. In some additional examples, the first low-functionality aliphatic polyisocyanate can be included in an amount of from 70 wt % to 99 wt % based on a total weight of the low-functionality aliphatic polyisocyanate. In some specific examples, the low-functionality aliphatic polyisocyanate can include the first low-functionality polyisocyanate in an amount of from 70 wt % to 80 wt %, from 75 wt % to 85 wt %, from 80 wt % to 90 wt %, or from 85 wt % to 95 wt % based on a total weight of the low-functionality aliphatic polyisocyanate.

In some examples, the low-functionality polyisocyanate can also include a second low-functionality aliphatic polyisocyanate. Where this is the case, the second low-functionality aliphatic polyisocyanate can have a number average functionality of from 2 to 3.5 based on gel permeation chromatography. In some further examples, the second low-functionality polyisocyanate can have a number average functionality of from 2.1 to 2.6, from 2.2 to 2.7, from 2.3 to 2.8, or from 2.4 to 2.9 based on gel permeation chromatography. Additionally, in some examples, the second low-functionality aliphatic polyisocyanate can have an NCO % of from 8 wt % to 20 wt % based on ISO 11909:2007. In some further examples, the second low-functionality aliphatic polyisocyanate can have an NCO % of from 8 wt % to 14 wt %, from 10 wt % to 16 wt %, or from 12 wt % to 18 wt % based on ISO 11909:2007. In some examples, the second low-functionality aliphatic polyisocyanate can have a weight average molecular weight of from 500 g/mol to 1500 g/mol based on gel permeation chromatography. In some additional examples, the second low-functionality aliphatic polyisocyanate can have a weight average molecular weight of from 600 g/mol to 1200 g/mol or from 700 g/mol to 1400 g/mol based on gel permeation chromatography. The second low-functionality aliphatic polyisocyanate can generally include a linear aliphatic polyisocyanate, a cycloaliphatic polyisocyanate, or an isocyanate-functional reaction product of an aliphatic polyisocyanate and an isocyanate-reactive material, or a combination thereof. In some specific examples, the second low-functionality aliphatic polyisocyanate can include a cycloaliphatic polyisocyanate. In some additional specific examples, the second low-functionality aliphatic polyisocyanate can include an IPDI polyisocyanate. In some further examples, the second low-functionality aliphatic polyisocyanate can include an allophanate.

Where the low-functionality aliphatic polyisocyanate includes the second low-functionality aliphatic polyisocyanate, the second low-functionality aliphatic polyisocyanate can generally be present in an amount of no more than 35 wt % based on a total weight of the low-functionality aliphatic polyisocyanate. In some examples, the second low-functionality aliphatic polyisocyanate can be present in an amount of from 1 wt % to 35 wt % based on a total weight of the low-functionality aliphatic polyisocyanate. In some specific examples, the second low-functionality aliphatic polyisocyanate can be present in an amount of from 1 wt % to 10 wt %, from 5 wt % to 15 wt %, from 10 wt % to 20 wt %, from 15 wt % to 25 wt %, or from 20 wt % to 30 wt % based on a total weight of the low-functionality aliphatic polyisocyanate.

Where the low-functionality aliphatic polyisocyanate includes the first and the second low-functionality aliphatic polyisocyanates, the first and the second low-functionality aliphatic polyisocyanates can be included at a variety of weight ratios. In some examples, the first low-functionality aliphatic polyisocyanate and the second low-functionality aliphatic polyisocyanate are present at a weight ratio of from 0.5:1 to 60:1 first to second low-functionality aliphatic polyisocyanate. In other examples, the first low-functionality aliphatic polyisocyanate and the second low-functionality aliphatic polyisocyanate are present at a weight ratio of from 2:1 to 30:1, or from 3:1 to 20:1 first to second low-functionality aliphatic polyisocyanate. In still additional examples, the first low-functionality aliphatic polyisocyanate and the second low-functionality aliphatic polyisocyanate are present at a weight ratio of from 1:1 to 5:1, from 3:1 to 8:1, from 5:1 to 10:1, or from 12:1 to 18:1 first to second low-functionality aliphatic polyisocyanate.

As described previously, in some examples, the aliphatic polyisocyanate resin can include a combination of a high-functionality aliphatic polyisocyanate and a low-functionality aliphatic polyisocyanate. Where this is the case, the high-functionality aliphatic polyisocyanate and the low-functionality aliphatic polyisocyanate can be present at a variety of weight ratios. In some examples, the high-functionality aliphatic polyisocyanate and the low-functionality aliphatic polyisocyanate can be present at a weight ratio of from 0.3:1 to 10:1 high-functionality aliphatic polyisocyanate to low-functionality aliphatic polyisocyanate. In some other examples, the high-functionality aliphatic polyisocyanate and the low-functionality aliphatic polyisocyanate can be present at a weight ratio of from 0.5:1 to 5.5:1 high-functionality aliphatic polyisocyanate to low-functionality aliphatic polyisocyanate. In some specific examples, the high-functionality aliphatic polyisocyanate and the low-functionality aliphatic polyisocyanate can be present at a weight ratio of from 0.5:1 to 2:1, from 1:1 to 3:1, from 2:1 to 4:1, or from 3:1 to 5:1 high-functionality aliphatic polyisocyanate to low-functionality aliphatic polyisocyanate.

Thus, the aliphatic polyisocyanate resin can include a variety of aliphatic polyisocyanates. Generally, the polyisocyanate composition does not include an aromatic polyisocyanate. In some examples, the polyisocyanate composition includes less than 5 wt %, less than 1 wt %, less than 0.1 wt %, or less than 0.01 wt % of an aromatic polyisocyanate.

The present disclosure also describes a method of manufacturing a polyisocyanate composition. The method can include combining a plurality of different aliphatic polyisocyanates to prepare an aliphatic polyisocyanate resin having a weight average molecular weight of from 1000 g/mol to 6000 g/mol based on gel permeation chromatography and having less than or equal to 50 wt % cycloaliphatic polyisocyanate based on a total weight of the aliphatic polyisocyanate resin. Solvent can optionally be added to adjust the NCO % of the polyisocyanate composition to from 2 wt % to 18 wt % based on ISO 11909:2007. The total solids content of the polyisocyanate composition can generally be from 84 wt % to 100 wt % based on a total weight of the polyisocyanate composition. The different aliphatic polyisocyanates that can be used to manufacture the polyisocyanate composition are described throughout this disclosure.

The polyisocyanate composition described herein can be part of a two-component (2K) polyurea or polyurethane coating system. Thus, the present disclosure also describes a 2K coating system including a polyisocyanate composition as described herein and a polyapartate composition or other isocyanate-reactive composition. The present disclosure also describes a low-VOC (e.g., less than or equal to 180 g VOCs/L of coating composition, for example) polyurea or polyurethane coating composition including a reaction product of an polyisocyanate composition as described herein and a polyaspartate composition or other isocyanate-reactive composition at an equivalent ratio of from 0.9:1 to 1.7:1 NCO:NH or NCO:OH. In some additional examples, the polyisocyanate composition can be combined with the polyaspartate composition or other isocyanate-reactive composition at an equivalent ratio of from 0.9:1 to 1.2:1, from 1.1:1 to 1.3:1, from 1.2:1 to 1.4:1, or from 1.3:1 to 1.5:1 NCO:NH or NCO:OH.

In some specific examples, the polyisocyanate composition can be combined with a polyaspartate composition to produce a coating composition. In further detail, polyaspartates may be produced by the reaction of a polyamine with a Michael addition receptor, i.e., an olefin substituted on one or both of the olefinic carbons with an electron withdrawing group such as cyano, keto or ester (an electrophile) in a Michael addition reaction. Examples of suitable Michael addition receptors include, but are not limited to, acrylates, and diesters such as dimethyl maleate, diethyl maleate, dibutyl maleate, dimethyl fumarate, diethyl fumarate, and dibutyl fumarate.

Additionally, the polyaspartate can be prepared with a variety of polyamines, including low molecular weight diamines, high molecular weight diamines, or a combination thereof. Additionally, the polyamines can have a wide range of amine functionality, repeat unit type, distribution, etc. This wide range of molecular weight, amine functionality, repeating unit type, and distribution can provide versatility in the design of new compounds or mixtures.

Suitable low molecular weight diamines have molecular weights in various embodiments of from 60 to 400, in selected embodiments of from 60 to 300. Suitable low-molecular-weight diamines include, but are not limited to, ethylene diamine, 1,2- and 1,3-diaminopropane, 1,5-diaminopentane, 1,3-, 1,4- and 1,6-diaminohexane, 1,3-diamino-2,2-dimethyl propane, 2-methylpentamethylenediamine, isophorone diamine, 4,4′-diamino-dicyclohexyl methane, 4,4-diamino-3,3′-dimethyldicyclohexyl methane, 1,4-bis(2-amino-prop-2-yl)-cyclohexane, hydrazine, piperazine, bis(4-aminocyclohexyl)methane, and and mixtures of such diamines Representative polyaspartates prepared from these low molecular weight diamines include DESMOPHEN NH-1220, DESMOPHEN NH-1420, and DESMOPHEN NH-1520, commercially available from COVESTRO.

In some additional embodiments of the invention, a single high molecular weight polyamine may be used. Also, mixtures of high molecular weight polyamines, such as mixtures of di- and trifunctional materials and/or different molecular weight or different chemical composition materials, may be used. The term “high molecular weight” is intended to include polyamines having a molecular weight of at least 400 in various embodiments. In selected embodiments, the polyamines have a molecular weight of from 400 to 6,000. Non-limiting examples can include polyethylene glycol bis(amine), polypropylene glycol bis(2-aminopropyl ether), the like, or a combination thereof.

In some specific examples, the polyamine can be an amine-terminated polyether. Commercially available examples of amine-terminated polyethers include, for example, the JEFFAMINE series of amine-terminated polyethers from Huntsman Corp., such as, JEFFAMINE D-230, JEFFAMINE D-400, JEFFAMINE D-2000, JEFFAMINE D-4000, JEFFAMINE T-3000 and JEFFAMINE T-5000.

In some examples, the polyaspartate may include one or more polyaspartates corresponding to formula (I):

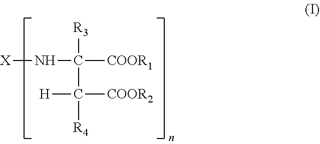

wherein:
n is an integer of at least 2;
X represents an aliphatic residue;
R₁ and R₂ independently of each other represent organic groups that are inert to isocyanate groups under reaction conditions; and
R₃ and R₄ independently of each other represent hydrogen or organic groups that are inert to isocyanate groups under reaction conditions.

In some additional examples, n has a value of from 2 to 6. In still additional examples, n has a value of from 2 to 4. In still additional examples, n has a value of 2.

In some examples, X represents an organic group that has a valency of n and is inert towards isocyanate groups at a temperature of 100° C. or less. In some additional examples, X represents a group obtained by removing amino groups from an aliphatic, araliphatic, or cycloaliphatic polyamine.

In some examples, R₁ and R₂ independently represent an alkyl group having from 1 to 9 carbon atoms. In some specific examples, R₁ and R₂ independently represent a methyl, ethyl, or butyl group. In still additional examples, R₁ and R₂, together form a cycloaliphatic or heterocyclic ring.

Other isocyanate-reactive compositions can also be combined with the low-NCO polyisocyanate compositions described herein. Other isocyanate-reactive compositions can generally include a polyol or a polyamine that is based on a polyether, a polyester, a polycarbonate, a polycarbonate ester, a polycaprolactone, a polybutadiene, the like, or a combination thereof, such as those described elsewhere herein. In some further examples, the isocyanate-reactive composition can include such a polyol or polyamine having a number average molecular weight of from 300 g/mol to 10,000 g/mol, from 400 g/mol to 6000 g/mol, or from 600 g/mol to 4000 g/mol.

Whether the polyisocyanate composition is combined with a polyaspartate composition or other isocyanate-reactive composition to form the coating composition, the polyaspartate composition or other isocyanate-reactive composition can generally have a relatively low solvent content. In some examples, the polyaspartate composition or other isocyanate-reactive composition can include less than or equal to 15 wt % total solvents based on a total weight of the polyaspartate composition or other isocyanate-reactive composition. In some additional examples, the polyaspartate composition or other isocyanate-reactive composition can include less than or equal to 10 wt % total solvents, or less than or equal to 8 wt % total solvents based on a total weight of the polyaspartate composition or other isocyanate-reactive composition. In some specific examples, the polyaspartate composition or other isocyanate-reactive composition can be 100 wt % solids, or greater than 99 wt % solids, or greater than 95 wt % solids based on a total weight of the polyaspartate composition or other isocyanate-reactive composition.

It is further noted that the polyisocyanate composition, the polyaspartate composition, the other isocyanate-reactive composition, or a combination thereof can optionally include one or more additives. Non-limiting examples of additives can include a flow aid, a surfactant, a thickener, a colorant, a solvent, a leveling agent, a blowing agent, the like, or a combination thereof.

The low-VOC coating composition can generally have a total solvent content (i.e., including exempt solvents) of less than or equal to 180 grams VOCs per liter of coating composition (g/L). In still additional examples, the low-VOC coating composition can have a total solvent content of less than or equal to 140 g/L, less than or equal to 120 g/L, or less than or equal to 100 g/L. In some further examples, the coating composition can have a total solids content of greater than or equal to 80 wt %, 85 wt %, 90 wt %, 91 wt %, 92 wt %, 93 wt %, 94 wt %, or 95 wt % based on a total weight of the coating composition.

Depending on the polyisocyanate composition and the polyasparate composition or other isocyanate-reactive composition employed, the coating composition can have a variety of initial viscosities. Generally, the coating composition can have an initial viscosity of from 1000 centipoise (cP) to 2000 cP at 23° C. based on ISO 3219:2003. As used herein, “initial viscosity” refers to the viscosity determined according to ISO 3219:2003, generally within the first 5 minutes after mixing. In some specific examples, the coating composition can have an initial viscosity of from 1000 cP to 1400 cP, from 1200 cP to 1600 cP, from 1400 cP to 1800 cP, or from 1600 cP to 2000 cP at 23° C. based on ISO 3219:2003.

Additionally, the coating composition can generally maintain a relatively low viscosity for a sufficient amount of time to apply the coating composition to a surface. For example, in some cases, the coating composition can increase to a viscosity of 2500 cP at 23° C. based on ISO 3219:2003 no sooner than 30 minutes after mixing or at least 30 minutes after mixing. In some additional examples, the coating composition can increase to a viscosity of 2500 cP at 23° C. based on ISO 3219:2003 at least 35 minutes after mixing, at least 40 minutes after mixing (i.e., no sooner than 40 minutes after mixing), at least 45 minutes after mixing (i.e., no sooner than 45 minutes after mixing), at least 50 minutes after mixing (i.e., no sooner than 50 minutes after mixing), or at least 60 minutes after mixing (i.e., no sooner than 60 minutes after mixing).

The coating composition can generally have an applied NCO % of from 2 wt % to 4.5 wt % based on a total weight of the coating composition. As used herein, “applied NCO %” refers to the NCO % of the coating composition, which can be calculated by dividing the total weight of NCO groups in the polyisocyanate composition by a total weight of the coating composition. In some additional examples, the coating composition can have an applied NCO % of from 2 wt % to 3 wt %, from 2.5 wt % to 3.5 wt %, from 3 wt % to 4 wt %, or from 3.5 wt % to 4.5 wt % based on a total weight of the coating composition.

In some additional examples, the coating composition can dry relatively quickly to form a dry coating, which is referred to herein as a hard-dry time. For example, in some cases, the coating composition can have a hard-dry time of from 1 hour to 7 hours based on ASTM D5895-03. In some additional examples, the coating composition can have a hard-dry time of from 1 hour to 3 hours, from 2 hours to 4 hours, from 3 hours to 5 hours, or from 4 hours to 6 hours based on ASTM D5895-03. Additionally, the coating composition can typically provide a coating having a pencil hardness of at least 3B, at least 1H, or at least 2H after hard dry.

The low-VOC coating composition can be coated on a variety of substrates. Non-limiting examples of substrates can include metals, plastics, wood, cement, concrete, glass, the like, or a combination thereof.

The low-VOC coating composition can be applied by spraying, knife coating, curtain coating, vacuum coating, rolling, pouring, dipping, spin coating, squeegeeing, brushing, squirting, printing, the like, or a combination thereof. Printing techniques can include screen, gravure, flexographic, or offset printing and also various transfer methods.

The low-VOC coating composition can be applied to substrate at a variety of coating thicknesses. For example, in some cases, the coating composition can be applied to a surface portion of a substrate at a coating thickness of from 1 thousandth of an inch (mil) to 16 mils. In other examples, the coating composition can be applied to a surface portion of a substrate at a coating thickness of from 1 mil to 5 mils, from 3 mils to 9 mils, from 6 mils to 12 mils, or from 10 mils to 16 mils.

### EXAMPLES

Materials used in the examples:

| | |
|---|---|
| Poly- | a 100% solids content aspartic ester functional amine, |
| aspartate | having an amine number of approx. 200 mg KOH/g, viscos- |
| A | ity @ 25° C. of 1100-1500 mPa · s; |
| Poly- | a 100% solids content aspartic ester functional amine, |
| aspartate | having an amine number of approx. 190 mg KOH/g, viscos- |
| B | ity @ 25° C. of 1000-1800 mPa · s; |
| Poly- | aliphatic polyisocyanate based on a reaction product of |
| isocyanate | HDI and a polyether polyol having an NCO % of 6% based |
| A | on ISO 11909: 2007, a weight average molecular weight |
| | of 6200 g/mol based on gel permeation chromatography, |
| | and a number average functionality of 4 based on gel |
| | permeation chromatography. |
| Poly- | aliphatic polyisocyanate based on HDI trimer having an |
| isocyanate | NCO % of 19.5% based on ISO 11909: 2007, a weight |
| B | average molecular weight of 3200 g/mol based on gel |
| | permeation chromatography, and a number average |
| | functionality of 4.6 based on gel permeation chroma- |
| | tography. |
| Poly- | cycloaliphatic polyisocyanate based on IPDI allophanate |
| isocyanate | having an NCO % of 15% based on ISO 11909: 2007, a |
| C | weight average molecular weight of 830 based on gel |
| | permeation chromatography, and a number average |
| | functionality of 2.5 based on gel permeation chroma- |
| | tography. |
| Poly- | aliphatic polyisocyanate based on allophanated HDI |
| isocyanate | trimer having an NCO % of 20 wt % based on ISO 11909: |
| D | 2007, a weight average molecular weight of 800 based on |
| | gel permeation chromatography, and a number average |
| | functionality of 2.5 based on gel penneation chroma- |
| | tography. |
| Additive A | a dispersing additive commercially available from BYK |
| Additive B | a silicone-free defoamer commercially available from BYK |
| Additive C | an amine-modified castor wax commercially available from |
| | PALMER HOLLAND |
| Additive D | a pigment commercially available from KRONOS |
| Additive E | a micronized functional filler commercially available |
| | from THE CARY COMPANY |
| Additive F | a micronized, highly porous, crystalline aluminosilicate |
| | commercially available from GRACE |
| Additive G | a liquid UV absorber commercially available from BASF |
| Additive H | a liquid hindered amine light stabilizer commercially |
| | available from BASF |
| Additive I | n-butyl acetate commercially available from SIGMA- |
| | ALDRICH |

The following polyaspartate composition recited in Table 1 is representative of the polyasparate composition used in each of the examples presented herein:

TABLE I
Polyaspartate Composition

| Material | Weight | Volume | Weight Solids | Volume Solids |
|---|---|---|---|---|
| Polyaspartate A | 85.14 | 9.64 | 85.14 | 9.68 |
| Polyaspartate B | 85.14 | 9.68 | 85.14 | 9.68 |
| Additive A | 15.09 | 1.77 | 7.85 | 0.83 |
| Additive B | 4.21 | 0.57 | 1.85 | 0.25 |
| Additive C | 16.63 | 1.95 | 16.63 | 1.95 |
| Additive D | 207.42 | 6.22 | 207.42 | 6.22 |
| Additive E | 154.96 | 7.11 | 154.96 | 7.11 |
| Additive F | 15.69 | 0.9 | 15.69 | 0.9 |
| Additive G | 8.31 | 0.85 | 8.31 | 0.85 |
| Additive H | 8.3 | 1 | 8.3 | 1 |
| Additive I | 73.37 | 9.97 | 0 | 0 |
| Total | 674.26 | 49.66 | 591.29 | 38.46 |

Numerous polyisocyanate compositions were prepared for individual combination with the polyaspartate composition. More specifically, Polyisocyanates A, B, C, and D were blended in various proportions to obtain various polyisocyanate compositions. Samples 1-3 are comparative examples that are not blended formulations. Samples 4-103 are inventive examples included blended formulations. The formulations of these polyisocyanate compositions are presented in Table II:

TABLE II
Formulations of Polyisocyanate Compositions

| | Poly- | Poly- | Poly- | Poly- |
|---|---|---|---|---|
| Sample | isocyanate A | isocyanate B | isocyanate C | isocyanate D |
| # | (%) | (%) | (%) | (%) |
| 1 (Comp.) | 100 | 0.0 | 0.0 | 0.0 |
| 2 (Comp.) | 0.0 | 100 | 0.0 | 0.0 |
| 3 (Comp.) | 0.0 | 0.0 | 0.0 | 100 |
| 4 | 0.0 | 17.1 | 44.3 | 38.6 |
| 5 | 25.6 | 27.3 | 14.2 | 32.9 |
| 6 | 0.0 | 55.1 | 0.0 | 44.9 |
| 7 | 38.3 | 41.0 | 6.0 | 14.8 |
| 8 | 47.2 | 33.5 | 1.3 | 18.0 |
| 9 | 74.0 | 23.4 | 0.0 | 2.6 |
| 10 | 0.0 | 35.4 | 7.9 | 56.7 |
| 11 | 0.0 | 38.1 | 0.0 | 61.9 |
| 12 | 40.0 | 40.0 | 10.0 | 10.0 |
| 13 | 54.0 | 26.8 | 19.2 | 0.0 |
| 14 | 84.6 | 15.4 | 0.0 | 0.0 |
| 15 | 20.4 | 42.7 | 9.5 | 27.4 |
| 16 | 0.0 | 25.7 | 32.8 | 41.5 |
| 17 | 12.2 | 38.5 | 0.0 | 49.4 |
| 18 | 50.7 | 19.4 | 29.9 | 0.0 |
| 19 | 18.1 | 67.5 | 0.0 | 14.4 |
| 20 | 24.7 | 40.4 | 0.0 | 35.0 |
| 21 | 11.1 | 59.5 | 5.2 | 24.2 |
| 22 | 0.0 | 53.0 | 0.0 | 47.0 |
| 23 | 35.6 | 36.2 | 18.2 | 10.1 |
| 24 | 28.4 | 42.1 | 0.0 | 29.5 |
| 25 | 0.0 | 31.1 | 23.0 | 45.8 |
| 26 | 2.9 | 27.7 | 22.3 | 47.1 |
| 27 | 0.0 | 30.5 | 9.8 | 59.7 |
| 28 | 65.8 | 30.9 | 3.2 | 0.0 |
| 29 | 2.3 | 25.1 | 24.5 | 48.1 |
| 30 | 4.0 | 25.2 | 28.8 | 42.0 |
| 31 | 48.8 | 29.3 | 21.9 | 0.0 |
| 32 | 23.2 | 57.5 | 0.0 | 19.3 |
| 33 | 18.4 | 55.0 | 12.3 | 14.3 |
| 34 | 11.3 | 32.4 | 20.3 | 36.0 |
| 35 | 19.2 | 54.4 | 0.0 | 26.4 |
| 36 | 8.3 | 65.5 | 3.6 | 22.7 |
| 37 | 10.9 | 30.6 | 19.6 | 39.0 |
| 38 | 80.2 | 19.8 | 0.0 | 0.0 |
| 39 | 8.9 | 30.2 | 22.0 | 38.9 |
| 40 | 64.9 | 28.2 | 6.9 | 0.0 |
| 41 | 39.2 | 35.4 | 1.9 | 23.5 |
| 42 | 37.8 | 28.2 | 12.7 | 21.4 |
| 43 | 20.6 | 37.1 | 12.3 | 30.1 |
| 44 | 16.4 | 45.2 | 9.2 | 29.2 |
| 45 | 0.0 | 43.8 | 0.0 | 56.2 |
| 46 | 0.0 | 46.8 | 0.0 | 53.2 |
| 47 | 35.6 | 34.1 | 8.9 | 21.3 |
| 48 | 66.4 | 31.1 | 0.5 | 2.0 |
| 49 | 49.9 | 15.7 | 34.4 | 0.0 |
| 50 | 13.8 | 64.4 | 1.9 | 20.0 |
| 51 | 7.7 | 58.1 | 6.2 | 28.0 |
| 52 | 30.1 | 36.2 | 4.4 | 29.3 |
| 53 | 0.0 | 50.4 | 0.0 | 49.6 |
| 54 | 33.9 | 30.9 | 29.4 | 5.8 |
| 55 | 74.7 | 23.2 | 2.1 | 0.0 |
| 56 | 22.8 | 40.6 | 7.3 | 29.3 |
| 57 | 16.9 | 30.8 | 26.8 | 25.5 |
| 58 | 8.2 | 25.4 | 25.5 | 40.9 |
| 59 | 38.5 | 17.2 | 39.5 | 4.8 |
| 60 | 30.6 | 20.2 | 36.9 | 12.3 |
| 61 | 30.0 | 23.6 | 32.2 | 14.3 |
| 62 | 82.0 | 17.7 | 0.2 | 0.1 |
| 63 | 26.0 | 57.6 | 0.0 | 16.3 |
| 64 | 18.1 | 63.9 | 0.0 | 18.0 |
| 65 | 14.8 | 29.2 | 34.3 | 21.6 |
| 66 | 45.3 | 23.1 | 28.4 | 3.1 |
| 67 | 0.0 | 25.8 | 35.4 | 38.8 |
| 68 | 1.4 | 35.0 | 22.7 | 40.9 |
| 69 | 15.6 | 64.2 | 5.7 | 14.6 |
| 70 | 7.3 | 63.2 | 6.3 | 23.2 |
| 71 | 29.3 | 31.3 | 18.9 | 20.5 |
| 72 | 15.4 | 64.8 | 0.0 | 19.7 |
| 73 | 49.3 | 25.2 | 16.1 | 9.4 |
| 74 | 72.6 | 27.4 | 0.0 | 0.0 |
| 75 | 2.5 | 60.4 | 1.9 | 35.2 |
| 76 | 0.0 | 25.8 | 20.9 | 53.4 |
| 77 | 6.4 | 25.4 | 34.2 | 34.0 |
| 78 | 15.9 | 38.2 | 5.4 | 40.5 |
| 79 | 0.0 | 29.4 | 27.4 | 43.2 |
| 80 | 39.3 | 32.2 | 0.5 | 28.0 |
| 81 | 41.3 | 43.8 | 6.6 | 8.3 |
| 82 | 0.0 | 45.3 | 0.0 | 54.7 |
| 83 | 0.0 | 30.2 | 37.5 | 32.3 |
| 84 | 30.9 | 47.8 | 11.1 | 10.1 |
| 85 | 0.0 | 26.1 | 22.6 | 51.4 |
| 86 | 6.5 | 34.1 | 12.4 | 47.0 |
| 87 | 3.0 | 29.4 | 18.5 | 49.1 |
| 88 | 12.9 | 66.4 | 0.0 | 20.7 |
| 89 | 0.0 | 22.8 | 41.4 | 35.8 |
| 90 | 35.4 | 23.0 | 31.6 | 10.0 |
| 91 | 57.0 | 26.1 | 14.8 | 2.1 |
| 92 | 0.0 | 28.4 | 46.6 | 25.0 |
| 93 | 0.0 | 25.4 | 41.7 | 32.9 |
| 94 | 74.9 | 25.1 | 0.0 | 0.0 |
| 95 | 67.3 | 22.6 | 10.1 | 0.0 |
| 96 | 10.8 | 50.9 | 22.3 | 16.1 |
| 97 | 44.3 | 25.1 | 29.2 | 1.4 |
| 98 | 71.3 | 22.5 | 6.1 | 0.0 |
| 99 | 36.2 | 51.5 | 2.3 | 10.0 |
| 100 | 65.8 | 29.6 | 1.3 | 3.2 |
| 101 | 0.0 | 28.0 | 30.2 | 41.8 |
| 102 | 28.9 | 57.9 | 0.0 | 13.1 |
| 103 | 0.0 | 22.3 | 45.7 | 32.1 |

Each of the formulations recited in Table II were evaluated to determine NCO % ISO 11909:2007, weight average molecular weight (Mw) based on gel permeation chromatography, and number average functionality based on gel permeation chromatography. Additionally, where the polyisocyanate compositions were diluted to less than 100% solids, butyl acetate was used as the solvent. These characteristics of the polyisocyanate compositions are recited in Table III:

TABLE III
Characteristics of Polyisocyanate Compositions

| Sample | NCO % | Mw | | % Solids |
|---|---|---|---|---|
| # | (wt %) | (g/mol) | Functionality | (%) |
| 1 (Comp.) | 6.0 | 6200 | 4.0 | 100.0 |
| 2 (Comp.) | 15.4 | 3200 | 4.6 | 80.0 |
| 3 (Comp.) | 19.5 | 800 | 2.5 | 100.0 |
| 4 | 15.2 | 1215 | 2.9 | 86.7 |
| 5 | 13.9 | 2835 | 3.5 | 90.6 |
| 6 | 17.0 | 2098 | 3.8 | 87.9 |
| 7 | 12.5 | 3846 | 4.0 | 89.5 |
| 8 | 11.9 | 4149 | 4.0 | 92.0 |
| 9 | 8.9 | 5365 | 4.1 | 94.5 |
| 10 | 17.2 | 1635 | 3.4 | 90.2 |
| 11 | 17.7 | 1697 | 3.4 | 91.3 |
| 12 | 12.0 | 3915 | 4.0 | 88.9 |
| 13 | 10.1 | 4366 | 3.9 | 89.7 |
| 14 | 7.7 | 5751 | 4.1 | 96.3 |
| 15 | 14.3 | 2915 | 3.8 | 88.5 |
| 16 | 15.7 | 1414 | 3.1 | 87.2 |
| 17 | 16.2 | 2369 | 3.6 | 91.2 |
| 18 | 10.0 | 4015 | 3.6 | 89.0 |
| 19 | 14.5 | 3372 | 4.2 | 85.6 |
| 20 | 14.6 | 3092 | 3.8 | 90.8 |
| 21 | 15.2 | 2805 | 4.0 | 86.1 |
| 22 | 17.1 | 2048 | 3.7 | 88.3 |
| 23 | 12.1 | 3590 | 3.8 | 88.0 |
| 24 | 14.1 | 3332 | 3.9 | 90.5 |
| 25 | 16.2 | 1538 | 3.2 | 88.1 |
| 26 | 16.0 | 1615 | 3.2 | 88.9 |
| 27 | 17.3 | 1520 | 3.2 | 90.8 |
| 28 | 9.6 | 5097 | 4.2 | 92.1 |
| 29 | 16.1 | 1522 | 3.1 | 89.0 |
| 30 | 15.5 | 1618 | 3.2 | 88.1 |
| 31 | 10.5 | 4143 | 3.8 | 88.7 |
| 32 | 14.2 | 3413 | 4.1 | 87.4 |
| 33 | 14.0 | 3097 | 4.0 | 85.6 |
| 34 | 15.0 | 2181 | 3.4 | 88.4 |
| 35 | 14.8 | 3123 | 4.0 | 88.0 |
| 36 | 15.4 | 2795 | 4.1 | 85.3 |
| 37 | 15.2 | 2118 | 3.4 | 88.9 |
| 38 | 8.2 | 5616 | 4.1 | 95.3 |
| 39 | 15.3 | 2000 | 3.3 | 88.5 |
| 40 | 9.5 | 4986 | 4.1 | 91.9 |
| 41 | 12.8 | 3760 | 3.9 | 91.5 |
| 42 | 12.5 | 3519 | 3.7 | 90.7 |
| 43 | 14.3 | 2795 | 3.6 | 89.0 |
| 44 | 14.8 | 2757 | 3.8 | 88.0 |
| 45 | 17.5 | 1831 | 3.5 | 90.1 |
| 46 | 17.4 | 1902 | 3.6 | 89.5 |
| 47 | 12.8 | 3536 | 3.8 | 90.3 |
| 48 | 9.7 | 5134 | 4.2 | 92.7 |
| 49 | 9.9 | 3886 | 3.5 | 88.9 |
| 50 | 14.9 | 3067 | 4.1 | 85.8 |
| 51 | 15.5 | 2588 | 3.9 | 86.2 |
| 52 | 13.8 | 3286 | 3.8 | 90.8 |
| 53 | 17.2 | 1987 | 3.7 | 88.8 |
| 54 | 11.7 | 3375 | 3.6 | 86.9 |
| 55 | 8.7 | 5399 | 4.1 | 94.1 |
| 56 | 14.3 | 2995 | 3.8 | 89.3 |
| 57 | 13.9 | 2449 | 3.4 | 87.4 |
| 58 | 15.3 | 1850 | 3.2 | 88.7 |
| 59 | 10.9 | 3304 | 3.4 | 87.6 |
| 60 | 12.0 | 2946 | 3.4 | 87.5 |
| 61 | 12.2 | 2993 | 3.4 | 87.8 |
| 62 | 8.0 | 5665 | 4.1 | 95.7 |
| 63 | 13.8 | 3567 | 4.2 | 87.4 |
| 64 | 14.6 | 3287 | 4.2 | 86.2 |
| 65 | 13.7 | 2299 | 3.4 | 86.3 |
| 66 | 10.7 | 3808 | 3.6 | 88.6 |
| 67 | 15.5 | 1417 | 3.1 | 86.7 |
| 68 | 15.9 | 1706 | 3.3 | 87.4 |
| 69 | 14.5 | 3161 | 4.1 | 85.1 |
| 70 | 15.4 | 2687 | 4.0 | 85.2 |
| 71 | 13.0 | 3132 | 3.6 | 88.8 |
| 72 | 14.8 | 3161 | 4.2 | 86.0 |
| 73 | 10.9 | 4072 | 3.8 | 90.6 |
| 74 | 9.0 | 5383 | 4.2 | 93.6 |
| 75 | 16.4 | 2359 | 3.9 | 86.5 |
| 76 | 16.6 | 1414 | 3.1 | 89.6 |
| 77 | 14.8 | 1755 | 3.2 | 87.0 |
| 78 | 15.3 | 2563 | 3.6 | 90.2 |
| 79 | 16.0 | 1500 | 3.2 | 87.6 |
| 80 | 13.0 | 3690 | 3.8 | 92.4 |
| 81 | 12.0 | 4074 | 4.1 | 88.8 |
| 82 | 17.4 | 1867 | 3.6 | 89.8 |
| 83 | 15.2 | 1522 | 3.2 | 85.5 |
| 84 | 12.8 | 3605 | 4.0 | 87.2 |
| 85 | 16.4 | 1421 | 3.1 | 89.2 |
| 86 | 16.1 | 1959 | 3.4 | 89.6 |
| 87 | 16.3 | 1660 | 3.2 | 89.3 |
| 88 | 15.1 | 3064 | 4.2 | 85.8 |
| 89 | 15.2 | 1348 | 3.0 | 86.2 |
| 90 | 11.7 | 3271 | 3.5 | 88.0 |
| 91 | 10.0 | 4511 | 3.9 | 90.7 |
| 92 | 14.6 | 1482 | 3.1 | 84.2 |
| 93 | 15.1 | 1410 | 3.1 | 85.6 |
| 94 | 8.8 | 5454 | 4.2 | 94.1 |
| 95 | 9.2 | 4985 | 4.0 | 92.4 |
| 96 | 14.3 | 2592 | 3.8 | 84.5 |
| 97 | 10.7 | 3802 | 3.7 | 88.0 |
| 98 | 8.9 | 5198 | 4.1 | 93.3 |
| 99 | 12.7 | 3978 | 4.2 | 88.1 |
| 100 | 9.7 | 5066 | 4.1 | 92.8 |
| 101 | 15.8 | 1467 | 3.2 | 87.3 |
| 102 | 13.5 | 3731 | 4.2 | 87.3 |
| 103 | 14.9 | 1338 | 3.0 | 85.5 |

The polyisocyanate compositions of Table II were individually combined with a polyaspartate composition having a general formulation according to Table I. The polyisocyanate compositions and polyaspartate composition were individually combined at an equivalent ratio of 1.05 (NCO:NH). After combination, viscosity measurements were taken initially and every 15 minutes thereafter. In accordance with this, the resulting coating compositions were evaluated to determine initial viscosity based on ISO 3219:2003, time to a viscosity of 2500 cP based on ISO 3219:2003, rate of viscosity change (ROC), hard-dry time based on ASTM D5895-03, and applied NCO %. The properties of the various coating compositions is recited in Table IV:

TABLE IV
Coating Composition Properties

| | Initial | | | Hard-Dry | Applied |
|---|---|---|---|---|---|
| Sample | Viscosity | Minutes to | ROC | Time | NCO % |
| # | (cP) | 2500 cP | (cP/min) | (hours) | (%) |
| 1 (Comp.) | 1806 | 43.7 | 12.8 | 9.00 | 2.2 |
| 2 (Comp.) | 2490 | 3.2 | 100.6 | 2.23 | 4.4 |
| 3 (Comp.) | 786 | 118.5 | 15.2 | 17.00 | 4.5 |
| 4 | 1758 | 24.1 | 38.8 | 7.91 | 4.3 |
| 5 | 1611 | 37.0 | 26.0 | 7.64 | 4.0 |
| 6 | 1398 | 26.8 | 46.2 | 4.46 | 4.4 |
| 7 | 2013 | 18.2 | 32.7 | 3.62 | 3.8 |
| 8 | 1792 | 31.2 | 27.2 | 5.53 | 3.7 |
| 9 | 2278 | 16.8 | 20.5 | 6.13 | 3.0 |
| 10 | 1168 | 42.9 | 31.6 | 6.98 | 4.4 |
| 11 | 1118 | 48.2 | 33.9 | 6.97 | 4.5 |
| 12 | 2219 | 10.8 | 32.9 | 3.43 | 3.7 |
| 13 | 2345 | 3.9 | 26.8 | 4.92 | 3.4 |
| 14 | 2222 | 20.6 | 17.2 | 6.79 | 2.7 |
| 15 | 1714 | 25.5 | 35.9 | 3.93 | 4.1 |
| 16 | 1592 | 26.9 | 35.0 | 7.14 | 4.3 |
| 17 | 1124 | 49.5 | 33.1 | 6.09 | 4.3 |
| 18 | 2243 | 6.0 | 28.8 | 6.68 | 3.4 |
| 19 | 2108 | 8.0 | 55.7 | 1.33 | 4.2 |
| 20 | 1325 | 42.5 | 33.2 | 4.86 | 4.1 |
| 21 | 1842 | 15.4 | 49.9 | 2.26 | 4.3 |
| 22 | 1358 | 29.1 | 44.5 | 4.73 | 4.5 |
| 23 | 2280 | 9.0 | 33.6 | 3.88 | 3.8 |
| 24 | 1460 | 37.1 | 34.0 | 4.23 | 4.0 |
| 25 | 1422 | 31.3 | 32.8 | 6.82 | 4.4 |
| 26 | 1381 | 35.8 | 29.7 | 7.47 | 4.3 |
| 27 | 1104 | 47.9 | 28.4 | 7.75 | 4.4 |
| 28 | 2480 | 4.4 | 24.3 | 4.58 | 3.2 |
| 29 | 1361 | 36.8 | 28.9 | 7.85 | 4.3 |
| 30 | 1562 | 30.3 | 31.6 | 7.53 | 4.3 |
| 31 | 2428 | 1.2 | 30.2 | 4.35 | 3.5 |
| 32 | 1868 | 17.0 | 46.0 | 1.87 | 4.1 |
| 33 | 2243 | 7.0 | 47.9 | 1.90 | 4.1 |
| 34 | 1653 | 28.5 | 32.3 | 6.26 | 4.2 |
| 35 | 1630 | 24.4 | 43.8 | 2.44 | 4.2 |
| 36 | 1899 | 12.4 | 55.5 | 2.04 | 4.3 |
| 37 | 1568 | 32.1 | 30.5 | 6.78 | 4.2 |
| 38 | 2318 | 15.6 | 18.8 | 6.14 | 2.9 |
| 39 | 1599 | 30.2 | 31.4 | 6.77 | 4.2 |
| 40 | 2392 | 6.0 | 23.2 | 4.88 | 3.2 |
| 41 | 1633 | 35.5 | 28.8 | 5.35 | 3.8 |
| 42 | 1834 | 29.0 | 25.6 | 6.77 | 3.8 |
| 43 | 1671 | 29.0 | 32.4 | 5.08 | 4.1 |
| 44 | 1680 | 24.9 | 38.1 | 3.74 | 4.2 |
| 45 | 1200 | 40.3 | 37.7 | 6.03 | 4.5 |
| 46 | 1248 | 36.4 | 39.8 | 5.58 | 4.5 |
| 47 | 1808 | 27.7 | 28.8 | 5.29 | 3.8 |
| 48 | 2423 | 8.5 | 24.4 | 4.85 | 3.2 |
| 49 | 2195 | 7.1 | 30.1 | 7.81 | 3.4 |
| 50 | 1929 | 12.6 | 53.4 | 1.68 | 4.2 |
| 51 | 1762 | 17.1 | 49.1 | 2.76 | 4.3 |
| 52 | 1527 | 37.4 | 30.0 | 5.38 | 4.0 |
| 53 | 1309 | 32.1 | 42.5 | 5.07 | 4.5 |
| 54 | 2490 | 2.6 | 37.2 | 4.42 | 3.7 |
| 55 | 2350 | 11.6 | 20.2 | 5.69 | 3.0 |
| 56 | 1607 | 30.6 | 33.7 | 4.41 | 4.1 |
| 57 | 2018 | 18.4 | 34.9 | 5.87 | 4.1 |
| 58 | 1577 | 32.2 | 29.6 | 7.74 | 4.2 |
| 59 | 2388 | 5.7 | 35.8 | 7.87 | 3.6 |
| 60 | 2367 | 9.3 | 35.2 | 7.61 | 3.8 |
| 61 | 2289 | 11.5 | 33.5 | 6.89 | 3.8 |
| 62 | 2264 | 18.2 | 18.0 | 6.49 | 2.8 |
| 63 | 1979 | 14.1 | 45.8 | 1.80 | 4.0 |
| 64 | 1954 | 12.6 | 52.2 | 1.52 | 4.2 |
| 65 | 2254 | 11.7 | 40.0 | 5.81 | 4.1 |
| 66 | 2318 | 6.0 | 30.2 | 6.08 | 3.5 |
| 67 | 1704 | 23.6 | 37.4 | 6.95 | 4.3 |
| 68 | 1567 | 26.3 | 35.8 | 6.12 | 4.3 |
| 69 | 2179 | 6.8 | 54.3 | 1.47 | 4.2 |
| 70 | 1925 | 12.0 | 54.2 | 2.27 | 4.3 |
| 71 | 1987 | 20.7 | 30.4 | 5.64 | 3.9 |
| 72 | 1904 | 13.3 | 53.3 | 1.59 | 4.2 |
| 73 | 2113 | 16.7 | 24.5 | 6.45 | 3.5 |
| 74 | 2463 | 8.0 | 22.3 | 5.13 | 3.1 |
| 75 | 1583 | 20.0 | 50.8 | 3.37 | 4.4 |
| 76 | 1212 | 41.3 | 27.7 | 7.91 | 4.4 |
| 77 | 1871 | 21.6 | 36.2 | 7.08 | 4.2 |
| 78 | 1335 | 40.6 | 32.3 | 5.56 | 4.2 |
| 79 | 1515 | 28.5 | 34.1 | 6.84 | 4.3 |
| 80 | 1465 | 44.5 | 27.2 | 6.52 | 3.8 |
| 81 | 2287 | 8.1 | 34.6 | 2.94 | 3.7 |
| 82 | 1224 | 38.3 | 38.7 | 5.80 | 4.5 |
| 83 | 1977 | 15.8 | 43.6 | 6.08 | 4.3 |
| 84 | 2306 | 6.4 | 40.0 | 2.30 | 3.9 |
| 85 | 1264 | 38.8 | 28.7 | 7.75 | 4.4 |
| 86 | 1325 | 38.7 | 30.9 | 6.62 | 4.3 |
| 87 | 1317 | 38.2 | 29.4 | 7.36 | 4.3 |
| 88 | 1886 | 13.2 | 55.1 | 1.64 | 4.3 |
| 89 | 1857 | 20.2 | 40.7 | 7.08 | 4.3 |
| 90 | 2319 | 9.4 | 32.6 | 6.75 | 3.7 |
| 91 | 2269 | 8.4 | 24.3 | 5.39 | 3.3 |
| 92 | 2397 | 7.3 | 52.9 | 5.80 | 4.2 |
| 93 | 1983 | 16.6 | 43.6 | 6.61 | 4.3 |
| 94 | 2421 | 10.2 | 21.1 | 5.43 | 3.0 |
| 95 | 2248 | 10.1 | 20.7 | 5.84 | 3.1 |
| 96 | 2362 | 5.0 | 50.6 | 2.66 | 4.2 |
| 97 | 2398 | 2.8 | 32.4 | 5.34 | 3.5 |
| 98 | 2281 | 11.3 | 20.0 | 5.83 | 3.1 |
| 99 | 2243 | 8.2 | 40.2 | 2.24 | 3.9 |
| 100 | 2337 | 11.7 | 23.7 | 5.16 | 3.2 |
| 101 | 1572 | 27.0 | 34.9 | 6.91 | 4.3 |
| 102 | 2113 | 10.4 | 45.7 | 1.76 | 4.0 |
| 103 | 2052 | 15.7 | 45.3 | 6.88 | 4.3 |

As can be seen from the results of Table IV, comparative Samples 1 and 3 had longer hard-dry times than any of blended Samples 4-103. Additionally, comparative Sample 2 had an excessively high ROC as compared to the blended samples 4-103. It is further noted that comparative Samples 1-3 resulted in final coating properties that were generally softer or more brittle than desired. However, when different polyisocyanates were blended together, it was possible to achieve a suitable ROC, hard-dry time, and final coating properties.

It should be understood that the above-described examples are only illustrative of some embodiments of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that variations including, may be made without departing from the principles and concepts set forth herein.

What is claimed is:

1. A polyisocyanate composition, comprising:
an aliphatic polyisocyanate resin having a weight average molecular weight of from 1000-6000 g/mol based on gel permeation chromatography, wherein the aliphatic polyisocyanate resin comprises a blend of at least two different aliphatic polyisocyanates and comprises less than or equal to 50 wt % of a cycloaliphatic polyisocyanate based on a total weight of the aliphatic polyisocyanate resin; and
wherein the polyisocyanate composition has an NCO % of from 2 wt % to 18 wt % based on ISO 11909:2007 and comprises from 84 wt % to 100 wt % solids based on a total weight of the polyisocyanate composition.

2. The polyisocyanate composition of claim 1, wherein the aliphatic polyisocyanate resin comprises an allophanate.

3. The polyisocyanate composition of claim 1, wherein the aliphatic polyisocyanate resin has a number average functionality of 2.9 to 4.3 based on gel permeation chromatography.

4. The polyisocyanate composition of claim 1, wherein the aliphatic polyisocyanate resin comprises a high-functionality aliphatic polyisocyanate having a number average functionality of from 3.5 to 5 based on gel permeation chromatography and a weight average molecular weight of from 2500 g/mol to 7000 g/mol based on gel permeation chromatography in an amount of from 15 wt % to 100 wt % based on a total weight of the aliphatic polyisocyanate resin.

5. The polyisocyanate composition of claim 4, wherein the high-functionality aliphatic polyisocyanate comprises a plurality of high-functionality aliphatic polyisocyanates.

6. The polyisocyanate composition of claim 4, wherein the high-functionality aliphatic polyisocyanate comprises a first high-functionality aliphatic polyisocyanate having a number average functionality of from 4 to 5 based on gel permeation chromatography, an NCO % of from 14 wt % to 22 wt % based on ISO 11909:2007, and a weight average molecular weight of from 2500 g/mol to 3800 g/mol based on gel permeation chromatography in an amount of from 15 wt % to 100 wt % based on a total weight of the high-functionality aliphatic polyisocyanate.

7. The polyisocyanate composition of claim 6, wherein the high-functionality aliphatic polyisocyanate comprises a second high-functionality aliphatic polyisocyanate having a number average functionality of from 3.5 to 4.5 based on gel permeation chromatography, an NCO % of from 2 wt % to 10 wt % based on ISO 11909:2007, and a weight average molecular weight of from 5500 g/mol to 7000 g/mol based on gel permeation chromatography in an amount no more than 85 wt % based on a total weight of the high-functionality aliphatic polyisocyanate.

8. The polyisocyanate composition of claim 1, wherein the aliphatic polyisocyanate resin comprises a low-functionality aliphatic polyisocyanate having a number average functionality of from 2 to 3.5 based on gel permeation chromatography and a weight average molecular weight of from 500 g/mol to 1500 g/mol based on gel permeation chromatography in an amount of from 0.1 wt % to 85 wt % based on a total weight of the aliphatic polyisocyanate resin.

9. The polyisocyanate composition of claim 8, wherein the low-functionality aliphatic polyisocyanate comprises a plurality of low-functionality aliphatic polyisocyanates.

10. The polyisocyanate composition of claim 8, wherein the low-functionality aliphatic polyisocyanate comprises a first low-functionality aliphatic polyisocyanate having a number average functionality of from 2 to 3.5 based on gel permeation chromatography, an NCO % of from 16 wt % to 25 wt % based on ISO 11909:2007, and a weight average molecular weight of from 500 g/mol to 1500 g/mol based on gel permeation chromatography.

11. The polyisocyanate composition of claim 10, wherein the first low-functionality aliphatic polyisocyanate is present in an amount of from 65 wt % to 100 wt % based on a total weight of the low-functionality aliphatic polyisocyanate.

12. The polyisocyanate composition of claim 8, wherein the low-functionality aliphatic polyisocyanate comprises a second low-functionality aliphatic polyisocyanate having a number average functionality of from 2 to 3.5 based on gel permeation chromatography, an NCO % of from 8 wt % to 15 wt % based on ISO 11909:2007, and a weight average molecular weight of from 500 g/mol to 1500 g/mol based on gel permeation chromatography.

13. The polyisocyanate composition of claim 12, wherein the second low-functionality aliphatic polyisocyanate is present in an amount of from 1 wt % to 35 wt % based on a total weight of the low-functionality aliphatic polyisocyanate.

14. The polyisocyanate composition of claim 12, wherein the second low-functionality aliphatic polyisocyanate comprises a cycloaliphatic polyisocyanate.

15. A coating composition, comprising:
the polyisocyanate composition of claim 1; and
a polyaspartate composition,
wherein the polyisocyanate composition and the polyaspartate composition are combined at an NCO:NH equivalent ratio of from 1:1 to 1.2:1, and wherein the coating composition has a total solvent content of less than or equal to 180 g/L.

16. The coating composition of claim 15, wherein the coating composition has an applied NCO % of from 2.5 wt % to 5 wt %.

17. The coating composition of claim 15, wherein the coating composition has an initial viscosity of from 1000 cP to 2000 cP at 23° C. based on ISO 3219:2003

18. A coated substrate, comprising:
a substrate having the coating composition of claim 16 applied to a surface portion thereof.

19. The coated substrate of claim 18, wherein the coating composition is applied at a coating thickness of from 1 mil to 16 mils.

20. A method of manufacturing a polyisocyanate composition, comprising:
combining a plurality of different aliphatic polyisocyanates to prepare an aliphatic polyisocyanate resin, wherein the aliphatic polyisocyanate resin has a weight average molecular weight of from 1000-6000 g/mol based on gel permeation chromatography and less than or equal to 50 wt % cycloaliphatic polyisocyanate based on a total weight of the aliphatic polyisocyanate resin; and
optionally adding solvent before, during, or after formation of the polyisocyanate resin,
wherein the polyisocyanate composition has an NCO % of from 2 wt % to 18 wt % based on ISO 11909:2007 and comprises from 84 wt % to 100 wt % solids based on a total weight of the polyisocyanate composition.
